(19) United States
(12) Patent Application Publication
(10) Pub. No.: US 2005/0219505 A1
(43) Pub. Date: Oct. 6, 2005

(54) Registering unit on a nozzle strip of a device for generating extremely fine liquid jet streams for the impingement thereof on a web of fibre

(76) Inventor: Gerold Fleissner, Zug (CH)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 10/502,952

(22) PCT Filed: Jan. 22, 2003
(86) PCT No.: PCT/EP03/00573

§ 371 Date: Apr. 21, 2005

(30) Foreign Application Priority Data
Jan. 30, 2002 (EP) 10203719.1

(51) Int. Cl. G01P 3/36

(52) U.S. Cl. 356/27

(57) ABSTRACT

A large number of water jets are necessary in order to stabilise waterjets or general impingement of said water jets on a web of fabrics. Said jets exit from a nozzle strip (14) which is provided with a number of holes. A hole or holes can become blocked during use, making it necessary to clean of all the strips (14) in order to achieve a consistent treatment result. A device is arranged on the water strip in order to monitor the water jets exiting therefrom. In order to monitor the water-jets exiting therefrom, a device is arranged on the water strip, said device being able to change step back and forth, in the region where the water jets exit from the water strip, for monitoring purposes along one section of the length of said water strip.

The invention relates to a jet manifold on a device for producing extremely fine fluid jets to hydrodynamically treat the fibers of a web passed along a manifold with said jets, said web being a fiber web, tissue, etc., or woven or knitted material, which manifold is composed of an upper section and a lower section extending along the working width of the web, wherein
a. a pressure chamber of circular cross-section is located along the length of the upper section, the fluid being fed in under pressure at, for example, the front face;
b. parallel thereto a pressure distribution chamber is provided in the lower section;
c. the pressure distribution chamber terminates in a narrow fluid outlet slit which is opposite the cross-section of the pressure distribution chamber; and
d. a jet strip is mounted in a fluid-tight manner above the fluid outlet slit, which strip has a multiplicity of jet openings, and thus a multiplicity of water jets emerging in parallel, and produces a dense fluid curtain.

A device of this species was disclosed in EP-A-0 725 175, the content and drawings of which are herein incorporated by reference. Water pressures of up to 1,000 bar are generated in the pressure chamber.

During operation of the water needling machine, the jet openings in the jet strip often become plugged. However, a fully functional jet strip is required in order to produce streak-free water needling. This requirement is especially true for products which are to undergo further processing after water needling for finishing purposes, such as, for example, in the case of synthetic leather or dyeing with textile applications.

In order to prevent the jet openings from becoming plugged, the first step is to ensure that only completely clean water flows to the jet openings. Nevertheless, over longer periods contamination of the jet strip cannot be avoided, the consequences of this contamination being nonuniform bonding or formation of streaks which can only be detected later on in the process during evaluation of the fabric web as finished product.

The goal of the invention is to find a device by which it is possible to determine continuously the very onset of the process in which the hole or multiple holes become plugged so as to be able to replace or immediately clean the jet strip.

This goal is achieved by providing or implementing an optical device to determine the actual discharge from the individual water jets of the fluid curtain below the fluid outlet slit of the lower section, that is, in the direction of flow of the emerging pressurized water behind the jet strip, said device being part of or independent of the lower section but in the region of the lower section, at least on one side of the water jets emerging one behind the other in tandem from the jet strip.

Use of this optical device, in other words, enables defective sites or incorrectly operating jet openings in the jet strip to be found quickly, and thereby also enabling an operator to remedy the situation quickly. The optical device may operate using light or other beams such as ultrasound or the like. A digital photoelectric cell or analogous data-acquiring devices may serve as the device which records and/or analyzes the sensing light beam. The detecting system should be connected to an electronic unit which operates by using the correlation principle and compares the entered data with the data actually measured, then issues an appropriate signal.

The device for determining the proper function of the jet strip, for monitoring all of the jet openings of the jet strip, does not need to extend along the entire length of the jet strip. Smaller or possibly multiple devices are also conceivable which oscillate along certain lengths, possibly overlapping lengths, of the jet strip while recording the data and relaying these data to the central unit.

The drawing illustrates an example of a jet manifold of the species improved according to the invention:

FIG. 1 is a longitudinal section through a conventional jet manifold;

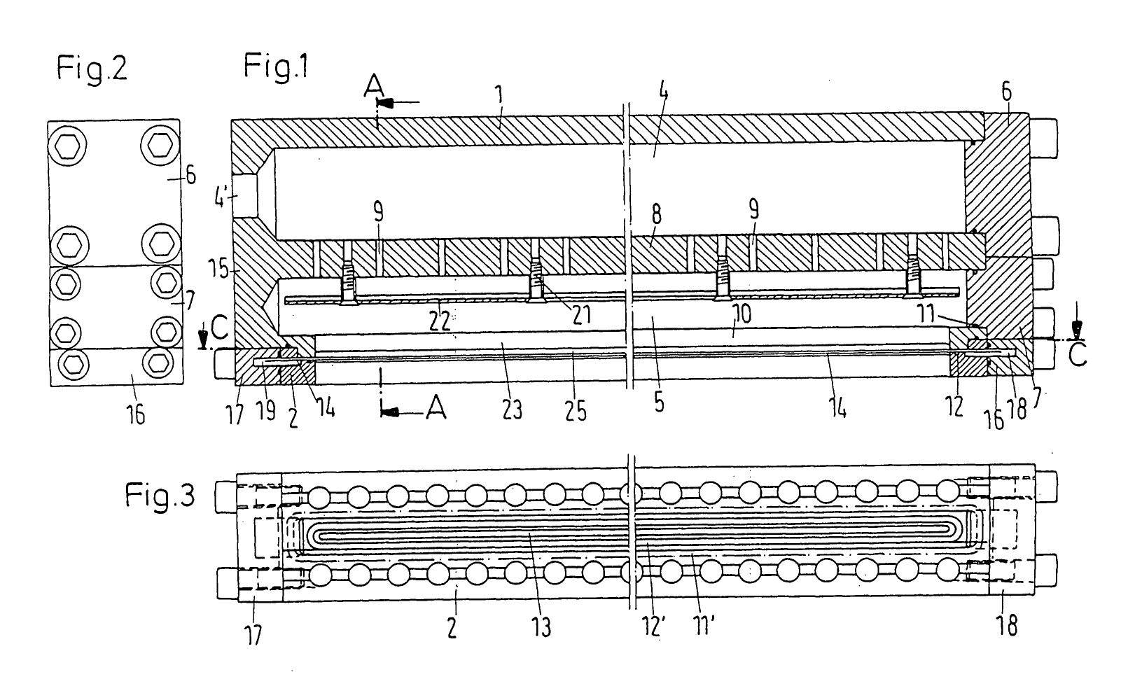

FIG. 2 is a view of the front of the jet manifold in FIG. 1;

FIG. 3 is a section along the line C-C in FIG. 1 with a view of the lower section of the jet manifold;

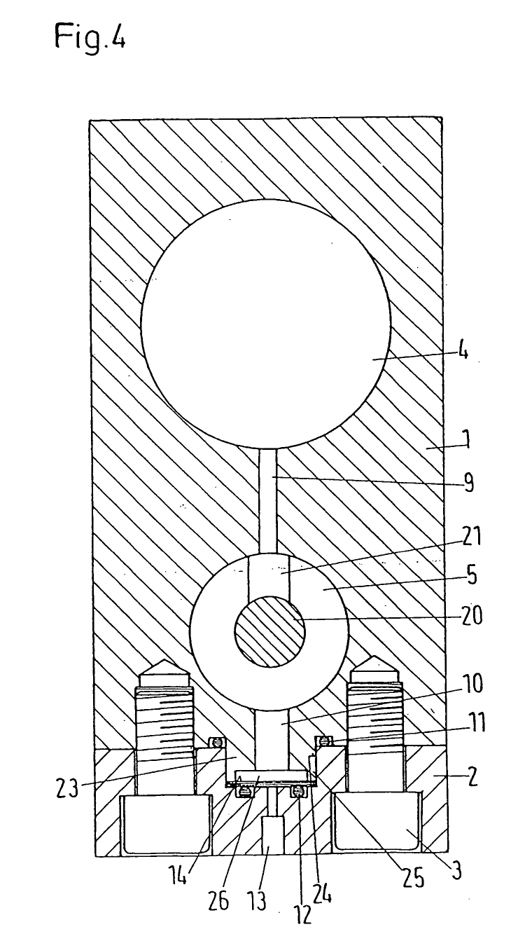

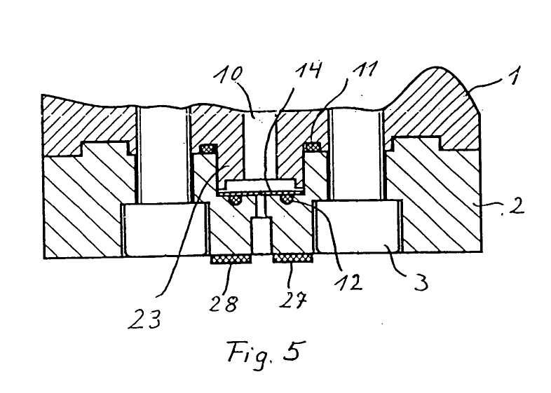

FIG. 4 is a transverse section through the jet manifold along line A-A in FIG. 1; and

FIG. 5 shows an enlarged section of the view in FIG. 4 in the lower area of the jet manifold.

The jet manifold seen in FIGS. 1-3 is known from EP-A-0 725 175; however, another similar device of the same principle may replace it here. The housing of the jet manifold is composed of an upper section 1 which is screwed on from below to the lower section 2 at multiple sites along its length using multiple screws, not shown here. Upper section 1 has two longitudinal bore holes 4 and 5, the upper bore hole being pressure chamber 4, and the lower bore hole being pressure distribution chamber 5. Both chambers are open at the one face, and have covers 6 and 7 screwed on in a fluid-tight manner. At their other face, pressure chamber 4 has an opening 4′ through which the fluid is introduced under pressure. The two chambers 4 and 5 are separated by a partition 8. Over the length of the jet manifold, a large number of passages 9 in partition 8 connect the two chambers such that the fluid entering pressure chamber 4 emerges in an evenly distributed manner into and over the length of pressure distribution chamber 5. The pressure distribution chamber is open at the bottom, specifically, through the narrow slit 10 opposite the diameter of the bore hole of pressure chamber 5, which slit also extends along the length of the manifold.

Upper section 1 is attached in a fluid-tight manner to lower section 2. The seal is achieved by the O-ring 11 which is inserted in a ring groove 11′ of upper section 1. At the center within O-ring 11, a spring projection 23 surrounds slit 10, the projection being fitted within a corresponding groove 25 of lower section 2. Within spring projection 23, a further repair groove 26 is provided to enable replacement of the jet strip 14. Yet another ring groove 12′ is incorporated within the base of groove 25 of lower section 2, into which groove O-ring 12 is inserted to seal jet strip 14. Another slit 13 is also incorporated within lower section 2 in a line below fluid passages 9 and slit 10, the upper part of slit 13 being quite narrow and leaving open only slightly more than the width of the effective jet openings of jet strip 14.

Aligned with covers 6, 7, and the rear housing wall 15, lower section 2 is screwed on in a fluid-tight manner by additional covers 16 and 17. Grooves 18, 19 are incorporated in covers 16, 17 at the level of jet strip 14, retained within the lower section, into which grooves jet strip 14 extends and can thus be easily grasped for replacement after covers 16 or 17 have been removed.

The fine jet openings in jet strip 14 easily become plugged and should be able to be detected and localized automatically. To this ends, a device 27, 28 is located in the region where the water jet emerges from the jet manifold out of slit 13 of lower section 2. This device may be composed of units operating in a variety of ways. It does not have to be located on both sides of the water curtain. It is sufficient to provide only one neutral background for the emerging jets so as to enable recording. In any case, the device is composed of a transmitter and a receiver. The transmitter is composed, for example, of a light source, while the receiver may consist of a light-sensitive optical device such as a digital camera which detects each water jet, or possible missing water jet, with millimeter precision, then relays this information to a recording device for the operator. The transmitter may also emit ultrasonic waves which then locate any missing water jet. It is possible for the device to operate in a stationary position; however, a better approach is to arrange the camera or the like so as to movably oscillate along the water curtain to enable it to monitor a larger area of the emerging water jets.

In all of these cases, installed device 27, 28 should operate on the correlation principle—meaning that the distance of the adjacent water jet and the thickness of each water jet is entered in a computer, thereby enabling it to make a comparison with reality. In other words, the camera makes a comparison with a reference pattern.

1. Jet manifold on a device for producing extremely fine fluid jets to hydrodynamically treat the fibers of a web passed along the manifold with said jets, said web being a fiber web, tissue, etc., or woven or knitted material, which manifold is composed of an upper section and a lower section extending along the working width of the web, wherein
a) a pressure chamber of circular cross-section is located along the length of the upper section, the fluid being fed in under pressure at, for example, the front face;
b) parallel thereto a pressure distribution chamber is provided in the lower section;
c) the pressure distribution chamber terminates in a narrow fluid outlet slit which is opposite the cross-section of the pressure distribution chamber; and
d) a jet strip is mounted in a fluid-tight manner above the fluid outlet slit, which strip has a multiplicity of jet openings, and thus a multiplicity of water jets emerging in parallel, and produces a dense fluid curtain.
characterized in that
e) an optical device (27, 28) is provided or implemented to determine the actual discharge from the individual water jets of the fluid curtain below the fluid outlet slit (13) of the lower section (2), that is, in the direction of flow of the emerging pressurized water behind the jet strip (14), said device being part of or independent of the lower section (2) but in the region of the lower section (2) at least on one side of the water jets emerging one behind the other in tandem from the jet strip (14).

2. Jet manifold according to claim 1, characterized in that the monitoring device (27, 28) is composed of a light source and a light-sensitive optical device.

3. Jet manifold according to claim 1, characterized in that the monitoring device (27, 28) is provided with ultrasonic sensors or the like.

4. Jet manifold according to claims 1-3, characterized in that the optical device or the like (27, 28) operates on the correlation principle.

5. Jet manifold according to claims 1-4, characterized in that the device (27, 28) covers only a portion of the length of the water curtain and is able to move, for example oscillate, over a larger portion of the length of the water curtain.

6. Jet manifold according to claim 5, characterized in that the device (27, 28) covers the entire length of the water curtain without any gaps, at least does so gradually over time.

7. Jet manifold according to claims 1-6, characterized in that the data recorded by the device (27, 28) is compared with a reference pattern, and any defective sites are recorded and relayed to an acoustic and/or optical unit.

8. Jet manifold according to claims 1 through 7, characterized in that the light source is mounted so as to oscillate together with the optical device or the like (27, 28).

9. Jet manifold according to claims 1 through 8, characterized in that the optical device or the like (27, 28) is located on one side of the water curtain, while a neutral, uniformly reflective background is located on the other side of the water curtain.
